(19) United States
(12) Patent Application Publication
(10) Pub. No.: US 2007/0235244 A1
(43) Pub. Date: Oct. 11, 2007

(54) Industrial truck, in particular high-bay order picker

(75) Inventors: Michael Lechtschewski, Langenbach (DE); Klaus Schroder, Beilngries (DE)

Correspondence Address: ROTHWELL, FIGG, ERNST & MANBECK, P.C., 1425 K STREET, N.W., SUITE 800, WASHINGTON, DC, 20005, US

(73) Assignee: Jungheinrich Aktiengesellschaft, Hamburg (DE)

(21) Appl. No.: 11/783,088

(22) Filed: Apr. 5, 2007

(30) Foreign Application Priority Data
Apr. 5, 2006 (DE) 10 2006 015 979.9

(51) Int. Cl. B60K 26/00; A47C 16/00

(52) U.S. Cl. 180/315; 180/333; 297/423.44

(57) ABSTRACT

Industrial truck, in particular high-bay order picker, having a standing platform (4) defining the occupation region (2) for an operator, a parapet (20) being provided on at least one side of the standing platform (4), characterized in that at least one vertically adjustable knee-support element (26) is provided in the parapet region on a rest (28), on which knee-support element an operator who is standing on the platform (4) and leaning against the parapet (20) can support himself with his knees.

The invention relates to an industrial truck, in particular a high-bay order picker, having a standing platform of a driver's stand defining the occupation region for an operator, a parapet being provided on at least one side of the standing platform.

With the industrial trucks under consideration here, an operator standing on the standing platform may reach beyond the parapet, if required, for example in order to take an article from a shelf and then to lay this article on a pallet or the like, which is held by load-accommodating means of the industrial truck on the other side of the parapet in the vicinity of the driver's position. The operator normally carries out such order-picking working steps whilst standing and can in the process support and restrain himself on the parapet. Towards the front, the parapet, in the upper region, is often in the form of an open frame with an upper horizontal transverse bar, which extends at a height of approximately 1 m from the standing platform.

It has also been shown to be virtually typical support behaviour for an operator who is oriented forwards towards the upper transverse bar of the parapet and who is supporting himself on the transverse bar with his upper body or stomach area to also attempt to support himself with his knees on a lower region of the parapet. It has already been proposed to design a rigid part of the parapet metal plate as a knee support with a thin cushion in the relevant height region of the parapet. Such knee-support metal plates are generally designed to be so large that operators with a low knee height and operators with a relatively high knee height can find a support surface thereon.

These relatively large knee-support metal plates represent a visual barrier in the parapet, however. Such an obstacle to visibility is particularly disadvantageous when the operator is not located directly at the parapet but, for example, is sitting on a seat, for example a folding seat, which is displaced slightly towards the rear and, in the process, is operating an operator's console in order to control the driving operation and the load-handling operation of the industrial truck. In such a case, the knee-support metal plates may represent an obstacle to the operator's view of components of the load-accommodating means or of the driven track.

The present invention is based on the object of providing an industrial truck of the type mentioned at the outset which provides a possibility of a knee support for various operators having different knee heights in the region of the driver's stand without necessarily representing a large visual barrier.

In order to achieve this object, the invention proposes that at least one vertically adjustable knee-support element is provided in the parapet region of the industrial truck on a rest, on which knee-support element an operator who is standing on the platform and leaning against the parapet can support himself with his knees.

The vertical adjustability of the knee-support element makes it possible for it to be matched to different knee heights of various operators, it being possible for the actual knee-support element to be designed to be relatively small, with the result that, simply for this reason, it does not represent an extensive visual barrier. Owing to the vertical adjustability, the knee-support element can in many cases also be displaced into a position in which it provides the operator with a free view through the parapet.

The knee-support element should have at least one cushioned region for the knee support, with the result that the operator will find a relatively soft and flexible supporting area in the knee region.

In accordance with a preferred configuration of the invention, the knee-support element is arranged on the rest such that it can be replaced using simple means. This provides the possibility of simply replacing a worn knee-support element with a new one or the possibility of using the mounting interface provided for detachably fixing the knee-support element to the industrial truck for fitting a component which only needs to be used temporarily, for example, such as a measuring device, a monitor etc. In this regard, the invention proposes that an adaptor element is provided which is provided for detachable connection to the mounting interface and is suitable and provided as a mount for the component to be fitted as a replacement for the knee-support element.

In accordance with a particularly preferred embodiment of the invention, the knee-support element and the rest have mutually complementary plug-in connection elements, which are assembled to form a plug-in connection. In this case, the knee-support element may have, for example, two plug-in rods as the plug-in connection elements, and the rest may be provided with plug-in holes for accommodating the plug-in rods. A plug-in connection mechanism, as is also used for holding head supports on backrests of motor vehicle seats, has been proven as a technically simple and functionally reliable solution of this nature. Such a plug-in mechanism makes it possible for the knee-support element to be removed if necessary by withdrawing the plug-in rods provided thereon from the rest-side plug-in holes, possibly once a latch-in catch has been released between the rest and the plug-in rods. Such a plug-in mechanism also makes it possible to adjust the height of the knee-support element quickly and easily. Depending on the specific embodiment of the plug-in mechanism, the knee-support element may be vertically adjustable in such a way that it can be fixed in various discrete latching positions or may be continuously vertically adjustable. This also applies to embodiments of connection mechanisms between the knee-support element and the rest which are not in the form of plug-in connections.

In accordance with a development of the invention, the knee-support element has two main sections, which protrude from one another at an angle of less than 180°, preferably less than 120° , and of which one is orientated upwards with an outer side and, on its lower side opposite this outer side, has plug-in rods as plug-in connection elements, the other main section facing the occupation region for the operator and having a cushion. Preferably, the angle formed by the main sections is approximately 90°, expediently the two main sections having a cushion. In the case of such a knee-support element, the operator can either support his knee forwards against the main section facing the occupation region or rest it on the upper main section. In addition, the bent-back configuration of the knee-support element makes it possible to cover angular and hard parapet elements in the relevant region of the parapet. In accordance with one variant of the abovementioned embodiment of the knee-support element, the upper main section has, on its outer side oriented upwards, a trough as a repository for writing utensils or the like.

Conventionally, the industrial trucks of the type under consideration here have an operator's console on the driver's stand which is arranged close to the parapet such that it can be reached from the occupation region of the operator. Expediently, at least one vertically adjustable knee-support element according to the invention is provided in the parapet region, laterally offset with respect to the operator's console.

The invention will be explained in more detail below with reference to the figures, in which:

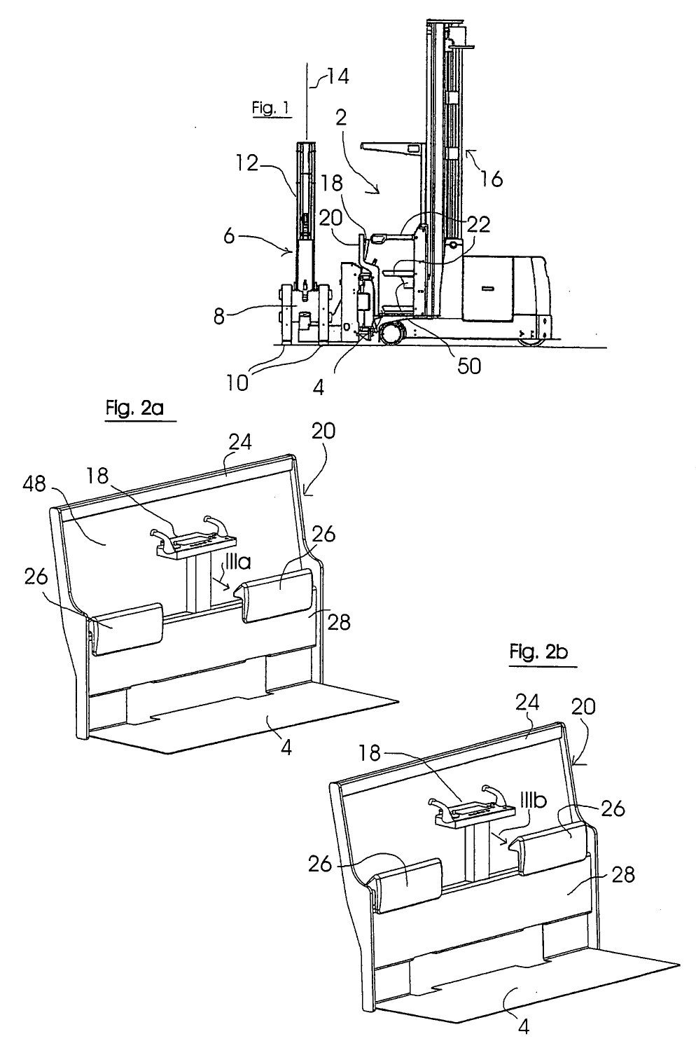

FIG. 1 shows, in a side view, a high-bay order picker as an industrial truck, in which the present invention is implemented.

FIGS. 2a and 2b show, in a perspective view, the front parapet region of the driver's stand of the industrial truck from FIG. 1 with a view of those sides of the vertically adjustable knee-support elements which face the driver's stand.

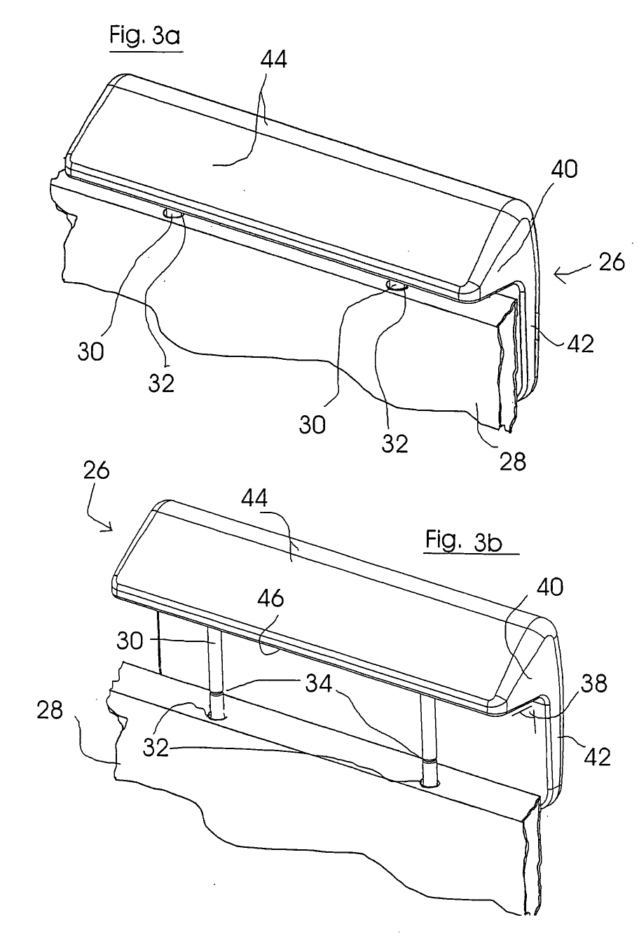

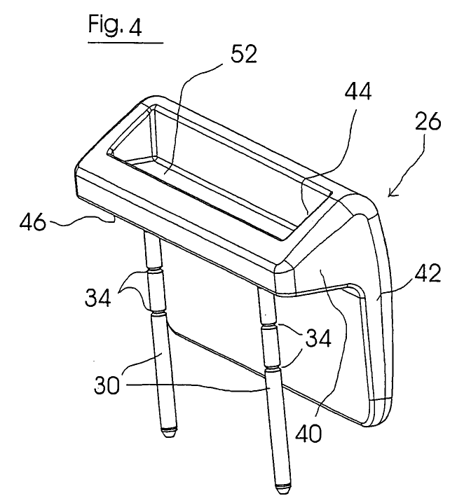

FIGS. 3a and 3b show the knee supports from FIGS. 2a and 2b from the perspectives indicated in FIGS. 2a and 2b by arrows IIIa and IIIb, the substructure of the knee-support elements being illustrated partially broken away in FIGS. 3a and 3b.

FIG. 4 shows a modified embodiment of the knee-support element from FIGS. 3a and 3b.

FIG. 1 shows a side view of a high-bay stacker, which i,s an electrical order picker/three-way stacker. The stacker in FIG. 1 has a driver's stand 2 with a standing platform 4 for the driver or the operator.

At the front on the driver's stand 2, a lateral reach device 6 with a fork carrier 8 and load-bearing forks 10 fixed thereto is provided. The fork carrier 8 which can be vertically adjusted on the additional mast 12 can be rotated with the additional mast 12 about the vertical axis 14 from the position shown with the load-bearing forks 10 oriented towards the viewer through approximately 180°, such that, after such a rotation, the load-bearing forks 10 are oriented such that they face away from the viewer in FIG. 1. The lateral reach device 6 can displace the additional mast 12 laterally, for example in order to pick up a pallet or the like from a high shelf. The additional mast 12 can also be adjusted into a rotary position in which the load-bearing forks 10 are aligned forwards, between the abovementioned rotary settings of the additional mast 12 with the lateral orientation of the load-bearing forks 10.

The driver's stand 2 can be moved vertically with the lateral reach device 6 on the main mast 16. These lifting movements of the driver's stand 2, the operational movements of the lateral reach device 6 and the driving movements of the entire industrial truck can be controlled by the operator from the driver's stand 2. For this purpose, a control panel 18 is provided in the region of the front parapet 20. The “manual” vehicle control by the operator can be assisted or possibly replaced by an automatic control system.

The driver's stand 2 has the already mentioned parapet 20 at the front towards the lateral reach device 6. At the side, the operator is secured in the driver's stand 2 against falling out of the driver's stand 2 by the lateral barrier elements 22 which can be folded upwards.

During normal order-picking operation, the operator generally works whilst standing in order to have a better overall view of the surrounding shelf environment and in order, if necessary, to gain access to shelf regions or to a pallet picked up by the load-bearing forks 10 beyond the driver's stand parapet 20. In this case, the operator can support himself with his hand, with the stomach area or with the upper body on the upper transverse bar 24 of the parapet 20 shown in FIG. 2a and FIG. 2b. Two knee-support elements 26, which are arranged laterally adjacent to the control panel 18 in the front parapet region such that they can be adjusted vertically, are used as further support aids. The parapet metal plate 28, which is canted at the top to form a box shape, is used as a rest for the knee-support elements 26.

FIG. 2a shows the knee-support elements 26 in their lowermost position, whereas, in FIG. 2b, they are illustrated in a raised position for higher knee heights.

FIG. 3a shows a knee-support element 26 in the position shown in FIG. 2a, to be precise from the perspective indicated in FIG. 2a by the arrow IIIa. The parapet metal-plate box 28 is illustrated broken away in FIG. 3a for reasons of simplicity.

FIG. 3b shows the knee-support element 26 in the withdrawn position shown in FIG. 2b from the front perspective, as is indicated by the arrow IIIb in FIG. 2b.

The parapet metal-plate box 28 and the knee-support element 26 have mutually complementary plug-in connection elements. As the plug-in connection elements, the plug-in rods (which are easily visible in FIG. 3b) are provided on the knee-support element 26 and are plugged into plug-in holes 32 in the upper side of the parapet metal-plate box 28. The plug-in holes 32 are part of plug-in receptacles, as are known from head support fixings in backrests of motor vehicle seats. The plug-in rods 30 are also correspondingly similar to the plug-in rods known from head supports.

The knee-support elements-26 can be plugged with their plug-in rods 30 to a greater or lesser extent, as required, into the plug-in holes 32 in order to perform a desired vertical adjustment. Latching mechanisms including the latching notches 34 shown in FIG. 3b make vertical adjustments in discrete steps possible.

In addition, FIGS. 3a and 3b clearly show that the knee-support elements 26 have two main sections 40, 42, which protrude at an angle 38 of approximately 90° from one another and are preferably both cushioned. The upper main section 40 is oriented upwards with its outer side 44 and has the plug-in rods 30 on its lower side 46. The other main section 42 faces the driver's stand or the occupation region for the operator. Such an angular shape of the knee-support element 26 has the advantage that it covers regions of hard and sharp-edged parapet elements, such as the upper region of the parapet metal-plate box 28, for example, and thus provides comfortable protection for the operator against an unintentional impact against the parapet metal-plate box 28 or the like (cf. in particular FIG. 2a and FIG. 3a).

This angular shape of the knee-support elements also makes it possible for the operator to rest his knee at the top on the section 44 (partially kneeling position) or to support his knee against the main section 42 towards the front (standing position).

Owing to the vertical adjustability of the knee-support elements, they can be matched quickly to different knee heights. They may be designed to be relatively small such that they block as little of the view for the operator in the window region 48 of the front parapet frame as possible (cf. FIG. 2a, FIG. 2b). The question of representing an obstacle to vision has particular significance when the operator is controlling the industrial truck in a seated position on a driver's seat 50, which is provided such that it can be folded out in the rear region of the driver's stand 2. In this case, the operator can be provided with virtually optimal viewing conditions if he displaces the relatively small knee-support element 26 into the lowermost position shown in FIG. 2a.

A modification of the exemplary embodiment explained above could consist in arranging the knee-support elements 26 such that they can also be displaced or possibly pivoted laterally, i.e. horizontally.

FIG. 4 shows a knee-support element 26, which, as a particular feature in comparison with the knee-support element 26 shown in FIG. 3a, has a trough 52 as a repository for writing utensils or the like on the upwardly oriented outer side 44 of the main section 40.

1. Industrial truck, in particular high-bay order picker, having a standing platform (4) defining the occupation region (2) for an operator, a parapet (20) being provided on at least one side of the standing platform (4), characterized in that at least one vertically adjustable knee-support element (26) is provided in the parapet region on a rest (28), on which knee-support element an operator who is standing on the platform (4) and leaning against the parapet (20) can support himself with his knees.

2. Industrial truck according to claim 1, characterized in that the knee-support element (26) is arranged on the rest (28) such that it can be replaced.

3. Industrial truck according to claim 1, characterized in that the knee-support element (26) has at least one cushioned region (40, 42) for the knee support.

4. Industrial truck according to claim 1, characterized in that the knee-support element (26) and the rest (28) have mutually complementary plug-in connection elements (30, 32), which are assembled to form a plug-in connection.

5. Industrial truck according to claim 4, characterized in that the knee-support element (26) has at least two plug-in rods (30) as the plug-in connection elements, whereas the rest (28) is provided with plug-in holes (32) for accommodating the plug-in rods (30).

6. Industrial truck according to claim 5, characterized in that the knee-support element (26) has two main sections (40, 42), which protrude from one another at an angle (38) of less than 180° and of which one is orientated upwards with an outer side (44) and, on its lower side (46) opposite this outer side (44), has the plug-in rods (30), the other main section (42) facing the occupation region (2) for the operator and having a cushion.

7. Industrial truck according to claim 6, characterized in that one main section (40a) has, on its outer side (44b) oriented upwards, a trough (52) as a repository for writing utensils or the like.

8. Industrial truck according to claim 1, characterized in that the knee-support element (26) is vertically adjustable in such a way that it can be fixed in various discrete latching positions.

9. Industrial truck according to claim 1, characterized in that the knee-support element (26) is substantially continuously vertically adjustable.

10. Industrial truck according to claim 1, characterized in that an operator's console (18) is arranged close to the parapet (20) such that it can be reached from the occupation region (2), and in that at least one vertically adjustable knee-support element (26) is provided in the parapet region, laterally offset with respect to the operator's console (18).

11. Industrial truck according to claim 10, characterized in that a seat (50) for the operator is available in the occupation region (2), from which seat the operator can actuate the operator's console (18).
